(19) United States
(12) Patent Application Publication
(10) Pub. No.: US 2024/0310339 A1
(43) Pub. Date: Sep. 19, 2024

(54) Data Processing Apparatus and Correction Method

(71) Applicant: SHIMADZU CORPORATION, Kyoto (JP)

(72) Inventors: Satoshi SHIMIZU, Kyoto-shi (JP); Satoshi SUGIMOTO, Kyoto-shi (JP); Kenta ADACHI, Kyoto-shi (JP)

(21) Appl. No.: 18/606,770

(22) Filed: Mar. 15, 2024

(30) Foreign Application Priority Data
Mar. 17, 2023 (JP) 2023-043018

(51) Int. Cl. G01N 30/86

(52) U.S. Cl. CPC G01N 30/8641; G01N 30/8631

(57) ABSTRACT

A processor obtains a first correspondence in which at least one reference peak detected from reference chromatogram data and at least one target peak detected from target chromatogram data are brought in correspondence with each other, obtains a second correspondence in which a reference data set included in the reference chromatogram data and a target data set included in the target chromatogram data are brought in correspondence with each other, by using a first similarity between the second correspondence and the first correspondence, and corrects a time axis of the target chromatogram data in accordance with the second correspondence.

### CROSS REFERENCE TO RELATED APPLICATIONS

This nonprovisional application is based on Japanese Patent Application No. 2023-043018 filed with the Japan Patent Office on Mar. 17, 2023, the entire contents of which are hereby incorporated by reference.

### BACKGROUND OF THE INVENTION

### Field of the Invention

The present disclosure relates to a data processing apparatus and a correction method, and more particularly to a technique to align a time axis of target chromatogram data obtained by a chromatograph apparatus with a time axis of reference chromatogram data defined as the reference.

### Description of the Background Art

In chromatographic analysis such as gas chromatography (GC) or liquid chromatography (LC), in spite of analysis by an identical apparatus under an identical condition, a retention time of an identical component may be different due to various factors such as temporal variation in flow rate of a mobile phase or deterioration of a column. Therefore, for comparison of a plurality of chromatograms, operations for correction of a time axis such that retention times of the identical component are substantially the same are preferably performed before the comparison.

Specifically, the time axis of target chromatogram data is corrected to be aligned with the time axis of reference chromatogram data defined as the reference.

For example, Japanese Patent Laying-Open No. 2011-220907 discloses detection of a peak in each of reference chromatogram data and target chromatogram data and correction of a time axis by bringing the detected peaks in correspondence with each other.

### SUMMARY OF THE INVENTION

In initial screening in which an analysis condition has not been optimized, separation of a peak is insufficient or a peak shape is bad. In detection of a peak from such a chromatogram, setting for detection of an appropriate peak is difficult and it takes time for making the setting, or a peak itself cannot be detected.

In a conventional correction method, a peak is detected, and a time axis is corrected by bringing detected peaks in correspondence with each other. Therefore, a retention time of a peak that is not detected is not successfully corrected.

In order to solve such a problem, a method of bringing not only peaks in reference chromatogram data and target chromatogram data in correspondence with each other but also bringing each measurement value (which is also referred to as a “reference data set” below) included in the reference chromatogram data and each measurement value (which is also referred to as a “target data set” below) included in the target chromatogram data in correspondence with each other may be applicable. Such a technique, however, imposes great burdens on a processing apparatus and an appropriate result may not be obtained with the technique.

One object of the present disclosure is to correct a time axis by bringing each reference data set included in reference chromatogram data and each target data set included in target chromatogram data in correspondence with each other while processing burdens are lessened.

A data processing apparatus in the present disclosure performs correction processing on target chromatogram data obtained by a chromatograph apparatus, to align a time axis of the target chromatogram data with a time axis of reference chromatogram data defined as a reference. The data processing apparatus includes a memory that stores chromatogram data obtained by the chromatograph apparatus and a processor that performs the correction processing. The processor is configured to obtain a first correspondence in which at least one reference peak detected from the reference chromatogram data and at least one target peak detected from the target chromatogram data are brought in correspondence with each other, obtain a second correspondence in which a reference data set included in the reference chromatogram data and a target data set included in the target chromatogram data are brought in correspondence with each other, by using a first similarity between the second correspondence and the first correspondence, and correct the time axis of the target chromatogram data in accordance with the second correspondence.

A correction method in the present disclosure is a method of aligning a time axis of target chromatogram data obtained by a chromatograph apparatus with a time axis of reference chromatogram data defined as a reference. The correction method includes obtaining a first correspondence in which at least one reference peak detected from the reference chromatogram data and at least one target peak detected from the target chromatogram data are brought in correspondence with each other, obtaining a second correspondence in which a reference data set included in the reference chromatogram data and a target data set included in the target chromatogram data are brought in correspondence with each other, by using a first similarity between the second correspondence and the first correspondence, and correcting the time axis of the target chromatogram data in accordance with the second correspondence.

The foregoing and other objects, features, aspects and advantages of this invention will become more apparent from the following detailed description of this invention when taken in conjunction with the accompanying drawings.

### BRIEF DESCRIPTION OF THE DRAWINGS

FIG. 1 is a diagram showing an overall configuration of an analysis system.

FIG. 2 is a diagram showing exemplary chromatogram data.

FIG. 3 is a flowchart of correction processing.

FIG. 4 is a diagram showing overview of the correction processing.

FIG. 5 is a diagram showing overview of linear correction processing.

FIG. 6 is a diagram showing overview of peak correspondence processing.

FIG. 7 is a diagram showing overview of data correspondence processing.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

### [Overall Configuration of Analysis System]

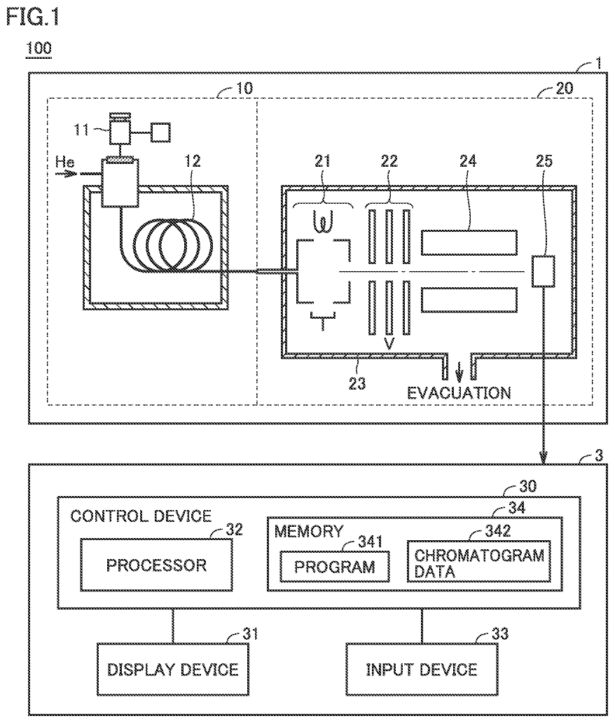

FIG. 1 is a diagram showing an overall configuration of an analysis system. An analysis system 100 includes a gas chromatograph mass spectrometer (which is referred to as a “GC/MS” below) 1 and a data processing apparatus 3. In the present embodiment, gas chromatograph data obtained by GC/MS 1 is assumed as chromatogram data to be corrected by way of example. The chromatogram data to be corrected should only be chromatogram data which is time-series data obtained by a chromatograph apparatus including a chromatograph for separation of various components contained in a sample and a detector that detects the sample subjected to component separation.

GC/MS 1 includes a gas chromatograph 10 and a mass spectrometer 20. Gas chromatograph 10 includes an injector 11 that introduces a sample and a column 12 in which a component of the sample introduced by injector 11 is separated. Each component contained in the sample introduced by injector 11 is separated while it passes through column 12, and each separated component is successively introduced into mass spectrometer 20.

Mass spectrometer 20 includes a vacuum chamber 23 evacuated by a not-shown vacuum pump as well as an ion source 21, a lens electrode 22, a quadrupole mass filter 24, and an ion detector 25 arranged in vacuum chamber 23.

Each component in the sample separated as it passes through column 12 of gas chromatograph 10 is successively introduced into ion source 21 of mass spectrometer 20 and ionized. The ionized component is converged by lens electrode 22, separated by quadrupole mass filter 24 in accordance with a mass-to-charge ratio (m/z), and thereafter detected by ion detector 25.

Mass spectrometer 20 can conduct scan measurement. In scan measurement, while mass spectrometer 20 scans the mass-to-charge ratio of ions that pass through quadrupole mass filter 24 within a prescribed range of the mass-to-charge ratio, it detects ions within the prescribed range of the mass-to-charge ratio with ion detector 25 for each mass-to-charge ratio. Scan measurement is conducted repeatedly at prescribed time intervals. Results of detection (mass spectral data sets) obtained by ion detector 25 are successively sent to data processing apparatus 3. The mass spectral data sets are thus obtained at the prescribed time intervals, and chromatogram data which is time-series data of mass spectra is obtained.

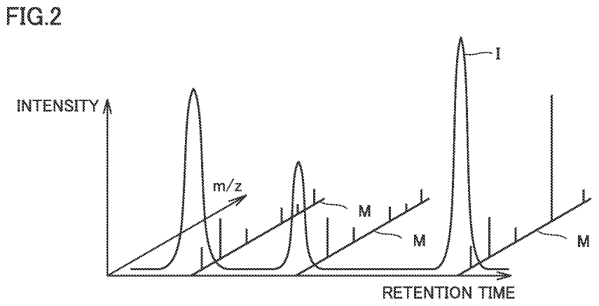

FIG. 2 is a diagram showing exemplary chromatogram data. The chromatogram data is time-series data of a plurality of measurement values (which are also referred to as “sample data sets” below). The chromatogram data includes a plurality of mass spectral data sets M. The chromatogram data may include total ion chromatogram (TIC) data I. TIC data I is time-series data of a total ion current which is a total of intensities of ions detected during one scan measurement.

Referring again to FIG. 1, data processing apparatus 3 includes a control device 30, an input device 31, and a display device 33. Data processing apparatus 3 may perform a function to control each component in GC/MS 1 in addition to a function to process chromatogram data. The function to control each component in GC/MS 1 may be performed by another apparatus different from data processing apparatus 3. In this case, data processing apparatus 3 may obtain a result of detection (chromatogram data) from a control device that performs the function to control each component in GC/MS 1.

Control device 30 includes a processor 32 and a memory 34. Processor 32 is implemented, for example, by a central processing unit (CPU), and it is processing circuitry that performs prescribed computing processing described in a program. Processor 32 reads a program and data stored in memory 34 to control each component in GC/MS 1 and to perform various types of processing for processing chromatogram data which will be described later.

Memory 34 includes a non-volatile memory or a volatile memory such as a read only memory (ROM) or a random access memory (RAM) and/or a mass storage such as a hard disc drive (HDD) or a solid state drive (SSD). A program 341 to be executed by processor 32 for performing various types of processing and a result of detection (chromatogram data 342) obtained by ion detector 25 are stored in memory 34.

Input device 31 and display device 33 are connected to control device 30. Input device 31 is implemented, for example, by a keyboard, a mouse, a pointing device, a touch panel, and/or the like and accepts an operation by a user. Display device 33 is implemented, for example, by a liquid crystal display (LCD) or an organic electro luminescence (EL) display, and shows various types of information stored in memory 34.

### [Flowchart of Correction Processing]

Control device 30 performs correction processing to align a time axis (retention time axis) of chromatogram data obtained by GC/MS 1 with a time axis (retention time axis) of chromatogram data defined as the reference. The chromatogram data to be corrected and the chromatogram data defined as the reference are referred to as “target chromatogram data” and “reference chromatogram data” below, respectively. A waveform obtained from the chromatogram data may simply be referred to as a “chromatogram.” Though two-dimensional TIC data I alone is illustrated as the chromatogram data below for the sake of convenience, the “chromatogram data” in the present embodiment includes time-series data of mass spectra and TIC data. Each sample data set included in the target chromatogram data and each sample data set included in the reference chromatogram data are referred to as a “target data set” and a “reference data set” below, respectively. Each sample data set included in TIC data I is two-dimensional data composed of a retention time and a signal intensity outputted from ion detector 25. Each sample data set included in mass spectral data set M is three-dimensional data composed of a retention time, a signal intensity, and a mass-to-charge ratio.

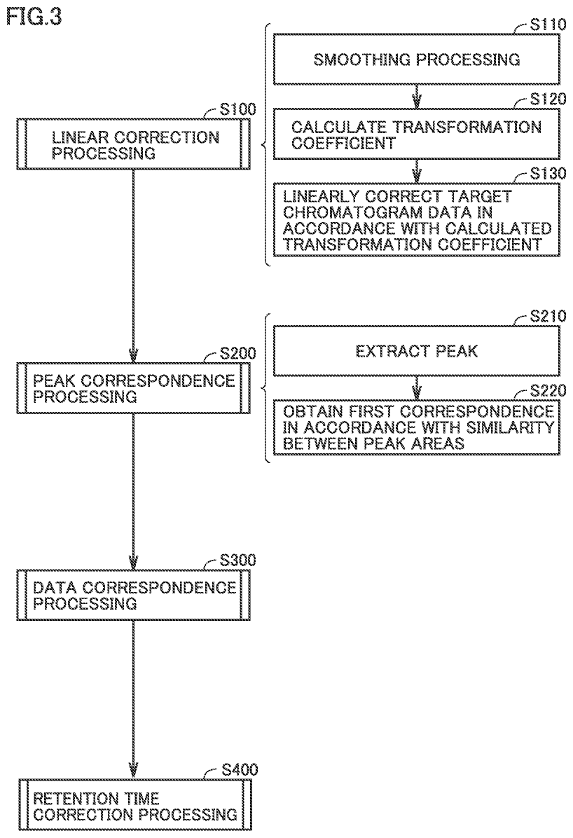

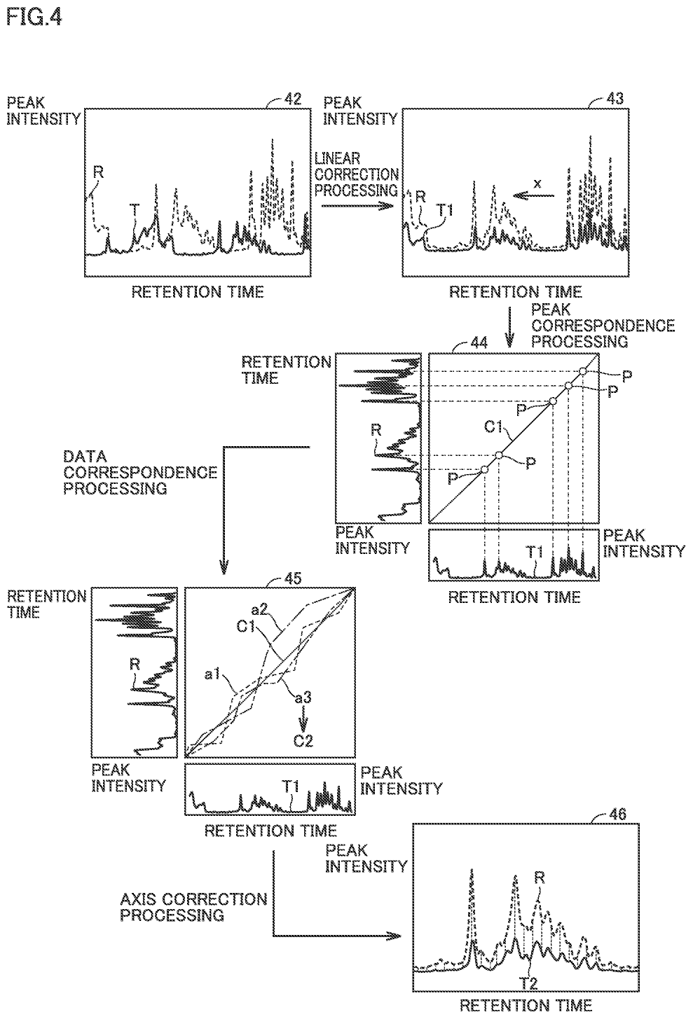

FIG. 3 is a flowchart of correction processing. FIG. 4 is a diagram showing overview of the correction processing. Referring to FIG. 3, the correction processing includes linear correction processing S100, peak correspondence processing S200, data correspondence processing S300, and retention time correction processing S400. Processor 32 performs the correction processing shown in FIG. 3 by reading and executing program 341 stored in memory 34.

In linear correction processing S100, processor 32 obtains target chromatogram data T1 by linearly correcting the entire waveform of target chromatogram data T to translate or warp such that a shape of the entire waveform of target chromatogram data T is similar to a shape of the entire waveform of reference chromatogram data R. Warping encompasses a concept of extension and contraction.

In graphs 42 and 43 in FIG. 4, the abscissa represents a time axis (retention time) and the ordinate represents a signal intensity (peak intensity) outputted from ion detector 25. In graphs 42 and 43, reference chromatogram data R is shown with a dashed line. In graphs 42 and 43, target chromatogram data T yet to be corrected and linearly corrected target chromatogram data T1 are shown with a solid line. In the example shown in FIG. 4, processor 32 obtains target chromatogram data T1 in graph 43 by translating target chromatogram data T in graph 42 in an x direction in the figure and contract the entire waveform.

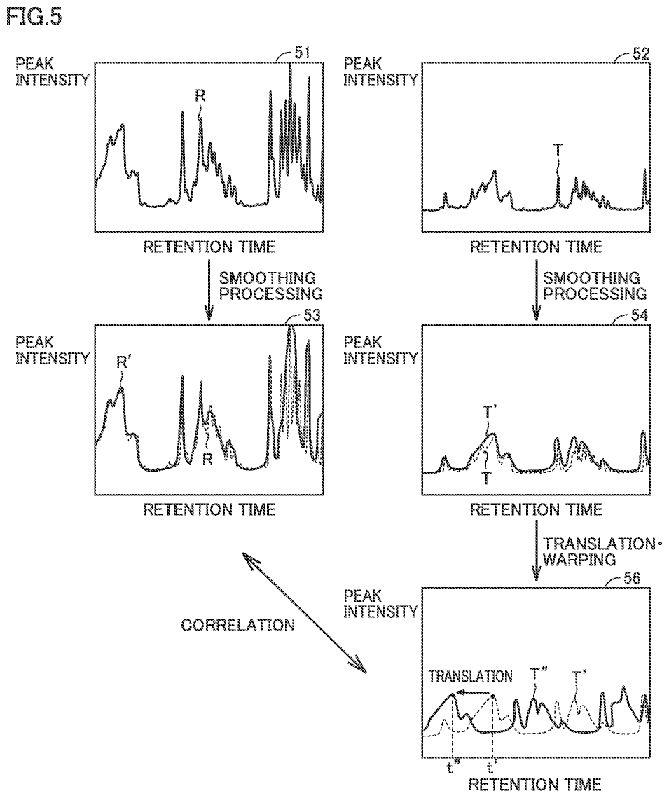

Processor 32 may make linear correction for achieving similarity between two-dimensional waveforms based on the TIC data or may make linear correction for achieving similarity between three-dimensional waveforms including a plurality of mass spectral data sets. Linear correction processing S100 includes S110 to S130 and details thereof will be described later with reference to FIG. 5.

In peak correspondence processing S200, processor 32 obtains a first correspondence C1 in which a peak extracted from target chromatogram data T1 and a peak extracted from reference chromatogram data R are brought in correspondence with each other.

In a graph 44 in FIG. 4, the abscissa represents a time axis (retention time) of target chromatogram data T1 and the ordinate represents a time axis (retention time) of reference chromatogram data R. Graph 44 shows five corresponding points P at which peaks extracted from reference chromatogram data R are brought in correspondence with respective peaks extracted from target chromatogram data T1 and first correspondence C1 which is connection of corresponding points P to one another.

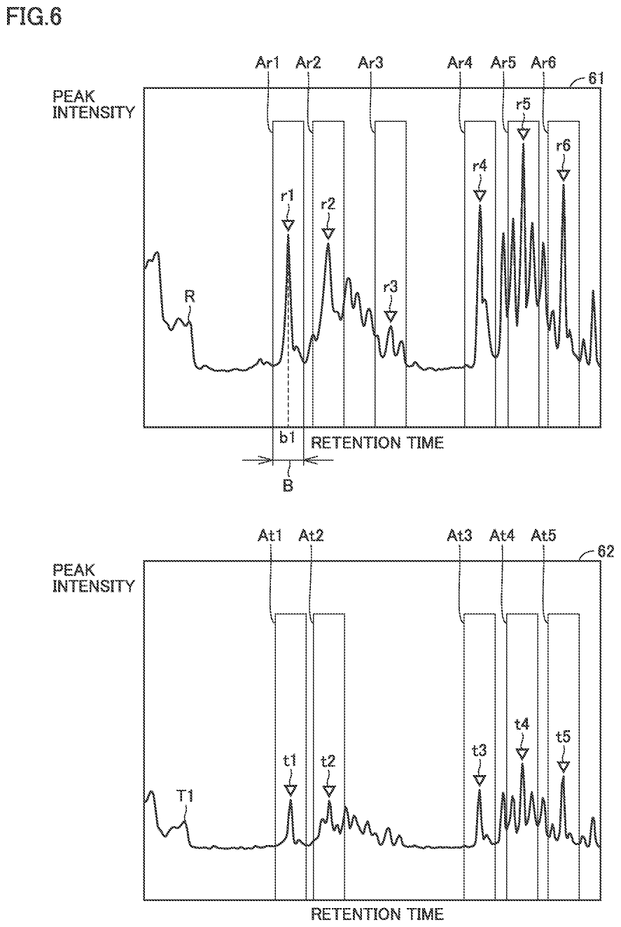

A method of establishing correspondence is not particularly limited. Processor 32 may calculate a similarity between peak shapes, a difference in timing of appearance of a peak (retention time), and the like as feature values, and obtain first correspondence C1 based on the calculated feature values. The feature values may include a similarity between mass spectra included in a peak range. Peak correspondence processing S200 includes S210 and S220 and details thereof will be described later with reference to FIG. 6.

In data correspondence processing S300, processor 32 obtains a second correspondence C2 by bringing a target data set included in target chromatogram data T1 and a reference data set included in reference chromatogram data R in correspondence with each other. Unlike the first correspondence in which peaks are brought in correspondence with each other, second correspondence C2 means a correspondence between the reference data set and the target data set and a correspondence between each section obtained by dividing reference chromatogram data R at prescribed intervals (for example, five-second intervals or the like) in a direction of the time axis and each section of target chromatogram data T1.

In a graph 45 in FIG. 4, the abscissa represents a time axis (retention time) of target chromatogram data T1 and the ordinate represents a time axis (retention time) of reference chromatogram data R. Graph 45 illustrates as candidates a1 to a3, lines obtained by connecting corresponding points at which the reference data set and the target data set are brought in correspondence with each other.

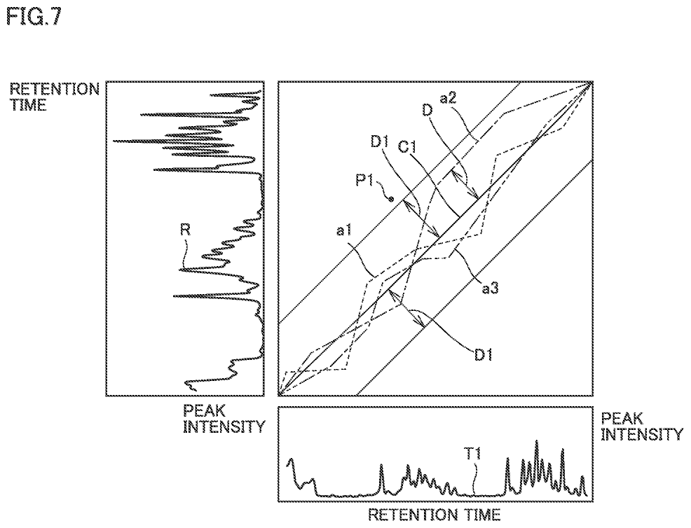

Processor 32 obtains a similarity between each candidate (for example, candidates a1 to a3 in FIG. 4) for second correspondence C2 and first correspondence C1 so as to avoid deviation from first correspondence C1 obtained in peak correspondence processing S200, and determines second correspondence C2 from a plurality of candidates based on the similarity. In FIG. 4, processor 32 is assumed to have determined candidate a3 as second correspondence C2. Though a further detailed processing method in data correspondence processing S300 will be described later with reference to FIG. 7, a feature value other than the similarity to first correspondence C1 may be used to obtain second correspondence C2 from the candidates.

In retention time correction processing S400, processor 32 obtains target chromatogram data T2 by correcting the retention time of each target data set in target chromatogram data T1 in accordance with second correspondence C2.

In a graph 46 in FIG. 4, the abscissa represents a time axis (retention time) and the ordinate represents a signal intensity (peak intensity) outputted from ion detector 25. Graph 46 shows reference chromatogram data R with a dashed line and shows with a solid line, target chromatogram data T2 obtained by correction in accordance with second correspondence C2.

Processor 32 corrects the retention time of the target data set to the retention time of the reference data set brought in correspondence in second correspondence C2. Second correspondence C2 is the correspondence between each section obtained by dividing reference chromatogram data R at prescribed intervals (for example, five-second intervals or the like) in the direction of the time axis and each section of target chromatogram data T1 as described above. In other words, in second correspondence C2, all target data sets are not brought in correspondence with the reference data sets. Then, the retention time of a target data set not brought in correspondence with a reference data set among the target data sets included in target chromatogram data T1 may be corrected by linear interpolation with the use of a target data set brought in correspondence with an adjacent reference data set.

In such correction processing, even when there is a peak that cannot be detected, the time axis of the sample data set of the peak that cannot be detected can also be corrected by bringing the sample data set of the reference chromatogram data and the sample data set of the target chromatogram data in correspondence with each other in data correspondence processing S300. In addition, by obtaining second correspondence C2 so as to be similar to a result of correspondence between the peaks in data correspondence processing S300, processing burdens imposed on processor 32 can be less than in search for second correspondence C2 without any indicator.

Furthermore, processor 32 performs peak correspondence processing S200 and data correspondence processing S300 after it performs linear correction processing S100. Since linear deviation of the retention time is corrected in advance and then the peaks are brought in correspondence with each other and the sample data sets are brought in correspondence with each other, burdens imposed on processor 32 involved with such correspondence can be lessened.

In the present embodiment, processor 32 roughly aligns target chromatogram data T with reference chromatogram data R in accordance with a shape of the entire waveform in linear correction processing S100. Thereafter, in peak correspondence processing S200, processor 32 brings a large peak (characteristic peak) that can be detected in correspondence, to create an indicator for bringing data sets in correspondence with each other. Finally, in data correspondence processing S300, processor 32 finely brings in correspondence, a data set hard to be detected as a peak, with reference to the obtained indicator (first correspondence C1). By thus establishing correspondence in a plurality of steps, burdens imposed on processor 32 can be lessened and correspondence can more accurately be established.

### [Linear Correction Processing S100]

Referring back to FIG. 3, linear correction processing S100 includes S110 to S130. S110 to S130 will be described in further detail with reference to FIG. 5. FIG. 5 is a diagram showing overview of the linear correction processing. In graphs 51 to 56, the abscissa represents a time axis (retention time) and the ordinate represents a signal intensity (peak intensity) outputted from ion detector 25.

In S110, processor 32 performs smoothing processing on reference chromatogram data R and target chromatogram data T. Graphs 51 and 52 show reference chromatogram data R and target chromatogram data T, respectively. Graphs 53 and 54 show with a solid line, a reference waveform R′ and a target waveform T′ resulting from the smoothing processing. Graphs 53 and 54 show with a dashed line, reference chromatogram data R and target chromatogram data T yet to be subjected to the smoothing processing.

As shown in FIG. 5, processor 32 performs the smoothing processing to create reference waveform R′ from reference chromatogram data R. In addition, processor 32 performs the smoothing processing to create target waveform T′ from target chromatogram data T.

In S120, processor 32 obtains a transformation coefficient for linear correction of the retention time of target chromatogram data T such that the shape of the entire waveform of target chromatogram data T is similar to the shape of the entire waveform of reference chromatogram data R. Processor 32 obtains correlation between the waveforms resulting from the smoothing processing, and repeats based on the correlation, linear transformation of target waveform T′ such that the correlation becomes higher.

Graph 56 shows a linearly corrected transformed waveform T″ and target waveform T′ yet to linearly be corrected, with a solid line and a dashed line, respectively. As shown in FIG. 5, correlation between reference waveform R′ and transformed waveform T″ resulting from linear transformation to translate or warp target waveform T′ in a direction of the retention time is obtained. For example, linear transformation can be expressed in an expression (1) below where t′ represents a retention time yet to linearly be corrected and t″ represents a linearly transformed retention time. a and b in the expression (1) are transformation coefficients.

t″=at′+b (1)

The correlation may be obtained by obtaining a correlation value between an image showing reference waveform R′ and an image showing linearly transformed waveform T″ with the use of an already known image processing technology. Processor 32 repeats linear transformation such that the obtained correlation is higher, stops linear transformation based on convergence of the correlation value indicating correlation, and sets as transformation coefficients a and b calculated in S120, transformation coefficients a and b for transformation of retention time t′ yet to linearly be transformed to linearly transformed retention time t″ at the time of convergence of the correlation value.

In S130, processor 32 obtains target chromatogram data T1 by linearly transforming retention time t of target chromatogram data T to translate or warp target chromatogram data T in accordance with the obtained transformation coefficients. Thereafter, processor 32 performs peak correspondence processing S200 and data correspondence processing S300 based on linearly transformed target chromatogram data T1.

By the smoothing processing as such, correlation can be obtained without being affected by a fine peak (for example, an outlier or the like) in the chromatogram data.

Processor 32 may obtain correlation with the use of a plurality of mass spectral data sets in addition to or instead of the TIC data. In other words, target waveform T′ and reference waveform R′ may be waveforms created based on the plurality of mass spectral data sets. In this case, processor 32 brings target waveform T′ in conformity with reference waveform R′ by linearly transforming target waveform T′ to translate or warp in the direction of the retention time. In the smoothing processing of the waveform created based on the plurality of mass spectral data sets, processor 32 may smooth the waveform along both of the retention time axis and the mass-to-charge ratio axis or only along the retention time axis.

Reference waveform R′ and target waveform T′ may each be a three-dimensional waveform of the retention time—the intensity—the mass-to-charge ratio created based on mass spectra. Correlation between three-dimensional waveforms may be obtained by using an already existing three-dimensional image processing technology. Alternatively, processor 32 may obtain a correlation value from a two-dimensional chromatogram obtained for each mass-to-charge ratio, and may search for a transformation coefficient such that a total of correlation values obtained for each mass-to-charge ratio is larger or a transformation coefficient such that all correlation values exceed a certain value.

By incorporating the plurality of mass spectral data sets, target chromatogram data T can be aligned with reference chromatogram data R, with the similarity of a component indicated by each peak being incorporated.

### [Peak Correspondence Processing S200]

Referring to FIG. 3, peak correspondence processing S200 includes S210 and S220. S210 and S220 will be described in further detail with reference to FIG. 6. FIG. 6 is a diagram showing overview of the peak correspondence processing. A graph 61 shows reference chromatogram data R and peaks r1 to r6 and peak areas Ar1 to Ar6 extracted from reference chromatogram data R. A graph 62 shows linearly transformed target chromatogram data T1 and peaks t1 to t5 and peak areas At1 to At5 extracted from target chromatogram data T1.

In S210, processor 32 extracts peaks from reference chromatogram data R and linearly corrected target chromatogram data T1. An existing method is available as a method of extracting peaks. A condition for extraction of peaks is stored in memory 34. The condition for extraction of peaks may be modified or may not be modified by a user.

The number of peaks extracted from each piece of the chromatogram data may be different. In the example shown in FIG. 6, it is assumed that six peaks r1 to r6 are extracted from reference chromatogram data R as shown in graph 61 and five peaks t1 to t5 are extracted from target chromatogram data T1 as shown in graph 62.

In S220, processor 32 obtains a similarity between waveforms in peak areas set around the extracted peaks and obtains the first correspondence in which the peaks are brought in correspondence with each other. Processor 32 may set as the peak area, a retention time B over a width around a retention time bl of a sample data set at a peak top of an extracted peak.

In the example shown in FIG. 6, it is assumed that six peak areas Ar1 to Ar6 are set in reference chromatogram data R as shown in graph 61 and five peak areas At1 to At5 are set in target chromatogram data T1 as shown in graph 62.

Processor 32 obtains the similarities between the respective waveforms in peak areas Ar1 to Ar6 and the respective waveforms in peak areas At1 to At5 and brings the peaks in correspondence with each other by bringing the waveforms in correspondence with each other based on the similarity. Processor 32 may use, for example, dynamic time warping (DTW) as a search method for bringing the waveforms in correspondence with each other. Though DTW will be described later, processor 32 can use a height, an inclination, or a retention time of the waveform as the feature value indicating the similarity between the waveforms.

By thus bringing the waveforms in the peak areas set around the extracted peaks in correspondence with each other, the waveforms can be brought in correspondence, with information around the peaks being incorporated. In particular, even when separation of the peak is insufficient and a starting point and an end point of the peak cannot accurately be detected, the peaks can be brought in correspondence with each other by setting the peak areas.

Processor 32 may use mass spectral data sets obtained at respective times in the peak area in addition to or instead of the TIC data. Processor 32 may obtain feature values with the height, the inclination, the mass-to-charge ratio, or the like of the peak indicating feature(s) of one or more mass spectral data sets obtained at time in the peak area being incorporated, and may bring the waveforms in correspondence with each other based on the similarity obtained based on comparison between feature values.

By incorporating information on mass spectra, the peaks can be brought in correspondence with each other, with the similarity between the components indicated by the peaks being incorporated.

### [Data Correspondence Processing S300]

FIG. 7 is a diagram showing overview of the data correspondence processing. In FIG. 7, the time axis of each sample data set is brought in correspondence, with the abscissa representing a time axis (retention time) of target chromatogram data T1 and the ordinate representing a time axis (retention time) of reference chromatogram data R, and FIG. 7 illustrates lines obtained by connecting corresponding points of sample data sets as candidates a1 to a3. FIG. 7 also shows first correspondence C1 obtained in peak correspondence processing S200.

As described with reference to FIG. 4, the similarity between each candidate (for example, candidates a1 to a3 in FIG. 4) for second correspondence C2 and first correspondence C1 is obtained so as to avoid deviation from first correspondence C1, and second correspondence C2 is obtained from among a plurality of candidates based on the similarity.

DTW may be used as the method of searching for second correspondence C2. DTW is a technique to check the similarity between two pieces of time-series data and a technique to check the similarity between the two pieces of time-series data by calculation on a round-robin basis, of feature values indicating the similarity between the pieces of data. In the present embodiment, processor 32 calculates the feature value indicating the similarity between the two pieces of chromatogram data on a round-robin basis to score relation (correspondence) between the pieces of data, and sets as second correspondence C2, the relation between the two pieces of chromatogram data that represents the highest similarity therebetween, based on a result of scoring.

Processor 32 uses the similarity to first correspondence C1 as the feature value. The similarity to first correspondence C1 corresponds to a distance D from first correspondence C1. The feature value may include the similarity in peak intensity between the two pieces of chromatogram data and the similarity between mass spectral data sets.

By using DTW and the similarity to first correspondence C1 for scoring in DTW, while such weighting as placing a weight on correspondence of a characteristic peak that can be detected in the entire waveform is made, data sets can finely be brought in correspondence with each other.

Processor 32 may exclude from the candidate for second correspondence C2, a correspondence in which the similarity to first correspondence C1 is equal to or smaller than a prescribed threshold value. For example, processor 32 obtains second correspondence C2 so as not to incorporate a corresponding point P1 at which distance D from first correspondence C1 is equal to or longer than a distance D1. Since the number of candidates for second correspondence C2 can thus be decreased, processing burdens imposed on processor 32 can be lessened.

### [Other Modifications]

In the embodiment, processor 32 is assumed to perform linear correction processing S100. Processor 32 may perform peak correspondence processing S200 and data correspondence processing S300 without performing linear correction processing S100. Though processor 32 is assumed to make linear correction based on the shape of the entire waveform as linear correction processing S100, a method of linear correction is not limited as such. For example, processor 32 may extract peaks and make linear correction by bringing the extracted peaks in correspondence.

In the embodiment, processor 32 is assumed to set the peak area and bring the peaks in correspondence based on the similarity between the waveforms in peak correspondence processing S200. Processor 32 may bring the extracted peaks in correspondence based on a feature (a peak width, a retention time, an inclination, or the like) of the peaks, without setting the peak area.

### [Aspects]

Illustrative embodiments described above are understood by a person skilled in the art as specific examples of aspects below.

(Clause 1) A data processing apparatus according to one aspect performs correction processing on target chromatogram data obtained by a chromatograph apparatus, to align a time axis of the target chromatogram data with a time axis of reference chromatogram data defined as a reference. The data processing apparatus includes a memory that stores chromatogram data obtained by the chromatograph apparatus and a processor that performs the correction processing. The processor is configured to obtain a first correspondence in which at least one reference peak detected from the reference chromatogram data and at least one target peak detected from the target chromatogram data are brought in correspondence with each other, obtain a second correspondence in which a reference data set included in the reference chromatogram data and a target data set included in the target chromatogram data are brought in correspondence with each other, by using a first similarity between the second correspondence and the first correspondence, and correct the time axis of the target chromatogram data in accordance with the second correspondence.

According to the data processing apparatus described in Clause 1, by obtaining the second correspondence based on the first similarity which is the similarity to the first correspondence which is a result of correspondence between peaks, processing burdens imposed on the processor can be less than in search for the second correspondence without any indicator.

(Clause 2) In the data processing apparatus described in Clause 1, the processor is configured to obtain the second correspondence, from a plurality of candidates for the second correspondence, by conducting a search using dynamic time warping, and use in the search, the first similarity as a feature value to be used for scoring of each of the plurality of candidates.

According to the data processing apparatus described in Clause 2, by using the similarity to the first correspondence for scoring in dynamic time warping, while such weighting as placing a weight on correspondence of a characteristic peak that can be detected in the entire waveform is made, data sets can finely be brought in correspondence with each other.

(Clause 3) In the data processing apparatus described in Clause 1 or 2, the processor does not incorporate in a candidate for the second correspondence, a correspondence including a corresponding point among corresponding points between the reference data set and the target data set, the first similarity being equal to or smaller than a predetermined threshold value at the corresponding point.

According to the data processing apparatus described in Clause 3, since the number of candidates for the second correspondence can be decreased, processing burdens imposed on the processor can be lessened.

(Clause 4) In the data processing apparatus described in any one of Clauses 1 to 3, the processor is configured to set a reference peak area for each peak of the at least one reference peak, with the reference peak being defined as the reference, set a target peak area for each peak of the at least one target peak, with the target peak being defined as the reference, and obtain a second similarity and obtain the first correspondence based on the second similarity, the second similarity being a similarity between a waveform of the chromatogram data included in the reference peak area and a waveform of the chromatogram data included in the target peak area.

According to the data processing apparatus described in Clause 4, by bringing the waveforms in the peak areas set around the extracted peaks in correspondence with each other, the waveforms can be brought in correspondence, with information around the peaks being incorporated. In particular, even when separation of the peak is insufficient and a starting point and an end point of the peak cannot accurately be detected, the peaks can be brought in correspondence with each other by setting the peak areas.

(Clause 5) In the data processing apparatus described in Clause 4, the chromatograph apparatus includes a mass spectrometer that performs mass spectrometry. The chromatogram data included in the reference peak area includes at least one reference mass spectral data set obtained from the mass spectrometer at time in the reference peak area. The chromatogram data included in the target peak area includes at least one target mass spectral data set obtained from the mass spectrometer at time in the target peak area. The second similarity is a similarity between a waveform of the at least one reference mass spectral data set included in the reference peak area and a waveform of the at least one target mass spectral data set included in the target peak area.

According to the data processing apparatus described in Clause 5, by incorporating information on mass spectra, the peaks can be brought in correspondence with each other, with the similarity of the component indicated by each peak being incorporated.

(Clause 6) In the data processing apparatus described in any one of Clauses 1 to 5, the processor is configured to obtain correlation between a transformed waveform and a reference waveform and linearly correct the target chromatogram data based on the correlation, the transformed waveform being obtained by translation or warping of a target waveform, the target waveform being a waveform of the target chromatogram data, the reference waveform being a waveform of the reference chromatogram data, and obtain the first correspondence and the second correspondence based on the linearly transformed target chromatogram data.

According to the data processing apparatus described in Clause 6, since linear deviation of the retention time is corrected in advance and then the first correspondence and the second correspondence are obtained, burdens imposed on the processor involved with such correspondence can be lessened.

(Clause 7) In the data processing apparatus described in Clause 6, the chromatograph apparatus includes a mass spectrometer that performs mass spectrometry. The target chromatogram data includes a target mass spectral data set obtained during each time period by the mass spectrometer. The reference chromatogram data includes a reference mass spectral data set obtained during each time period by the mass spectrometer. The target waveform is a waveform created from obtained target mass spectral data sets. The reference waveform is a waveform created from obtained reference mass spectral data sets.

According to the data processing apparatus described in Clause 7, by incorporating the mass spectral data sets, the target chromatogram data can be aligned with the reference chromatogram data, with the similarity of a component indicated by each peak being incorporated.

(Clause 8) In the data processing apparatus described in Clause 6 or 7, the processor performs smoothing processing on the reference chromatogram data to create the reference waveform and the target chromatogram data to create the target waveform.

According to the data processing apparatus described in Clause 8, by performing the smoothing processing, correlation can be obtained without being affected by a fine peak (for example, an outlier or the like) in the chromatogram data.

(Clause 9) A correction method according to one aspect is a method of aligning a time axis of target chromatogram data obtained by a chromatograph apparatus with a time axis of reference chromatogram data defined as a reference. The correction method includes obtaining a first correspondence in which at least one reference peak detected from the reference chromatogram data and at least one target peak detected from the target chromatogram data are brought in correspondence with each other, obtaining a second correspondence in which a reference data set included in the reference chromatogram data and a target data set included in the target chromatogram data are brought in correspondence with each other, by using a first similarity between the second correspondence and the first correspondence, and correcting the time axis of the target chromatogram data in accordance with the second correspondence.

(Clause 10) A program according to one aspect is a program for causing a computer to perform the correction method described in Clause 9.

(Clause 11) A computer readable medium according to one aspect stores the program described in Clause 10.

According to the correction method, the program, and the computer readable medium described in Clauses 9 to 11, by obtaining the second correspondence based on the first similarity which is the similarity to the first correspondence which is a result of correspondence between peaks, processing burdens imposed on the computer can be less than in search for the second correspondence without any indicator.

The embodiment disclosed herein is also intended to be carried out as being combined as appropriate within the technically consistent scope. It should be understood that the embodiment disclosed herein is illustrative and non-restrictive in every respect. The scope of the present invention is defined by the terms of the claims rather than the description of the embodiment above and is intended to include any modifications within the scope and meaning equivalent to the terms of the claims.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A data processing apparatus that performs correction processing on target chromatogram data obtained by a chromatograph apparatus, to align a time axis of the target chromatogram data with a time axis of reference chromatogram data defined as a reference, the data processing apparatus comprising:
a memory that stores chromatogram data obtained by the chromatograph apparatus; and
a processor that performs the correction processing, wherein
the processor is configured to
obtain a first correspondence in which at least one reference peak detected from the reference chromatogram data and at least one target peak detected from the target chromatogram data are brought in correspondence with each other,
obtain a second correspondence in which a reference data set included in the reference chromatogram data and a target data set included in the target chromatogram data are brought in correspondence with each other, by using a first similarity between the second correspondence and the first correspondence, and
correct the time axis of the target chromatogram data in accordance with the second correspondence.

2. The data processing apparatus according to claim 1, wherein
the processor is configured to
obtain the second correspondence, from a plurality of candidates for the second correspondence, by conducting a search using dynamic time warping, and
use in the search, the first similarity as a feature value to be used for scoring of each of the plurality of candidates.

3. The data processing apparatus according to claim 1, wherein
the processor does not incorporate in a candidate for the second correspondence, a correspondence including a corresponding point among corresponding points between the reference data set and the target data set, the first similarity being equal to or smaller than a predetermined threshold value at the corresponding point.

4. The data processing apparatus according to claim 1, wherein
the processor is configured to
sets a reference peak area for each peak of the at least one reference peak, with the reference peak being defined as the reference,
set a target peak area for each peak of the at least one target peak, with the target peak being defined as the reference, and
obtain a second similarity and obtain the first correspondence based on the second similarity, the second similarity being a similarity between a waveform of the chromatogram data included in the reference peak area and a waveform of the chromatogram data included in the target peak area.

5. The data processing apparatus according to claim 4, wherein
the chromatograph apparatus includes a mass spectrometer that performs mass spectrometry,
the chromatogram data included in the reference peak area includes at least one reference mass spectral data set obtained from the mass spectrometer at time in the reference peak area,
the chromatogram data included in the target peak area includes at least one target mass spectral data set obtained from the mass spectrometer at time in the target peak area, and
the second similarity is a similarity between a waveform of the at least one reference mass spectral data set included in the reference peak area and a waveform of the at least one target mass spectral data set included in the target peak area.

6. The data processing apparatus according to claim 1, wherein
the processor is configured to
obtain correlation between a transformed waveform and a reference waveform and linearly correct the target chromatogram data based on the correlation, the transformed waveform being obtained by translation or warping of a target waveform, the target waveform being a waveform of the target chromatogram data, the reference waveform being a waveform of the reference chromatogram data, and
obtain the first correspondence and the second correspondence based on the linearly transformed target chromatogram data.

7. The data processing apparatus according to claim 6, wherein
the chromatograph apparatus includes a mass spectrometer that performs mass spectrometry,
the target chromatogram data includes a target mass spectral data set obtained during each time period by the mass spectrometer,
the reference chromatogram data includes a reference mass spectral data set obtained during each time period by the mass spectrometer,
the target waveform is a waveform created from obtained target mass spectral data sets, and
the reference waveform is a waveform created from obtained reference mass spectral data sets.

8. The data processing apparatus according to claim 6, wherein
the processor performs smoothing processing on the reference chromatogram data to create the reference waveform and the target chromatogram data to create the target waveform.

9. A correction method of aligning a time axis of target chromatogram data obtained by a chromatograph apparatus with a time axis of reference chromatogram data defined as a reference, the correction method comprising:
obtaining a first correspondence in which at least one reference peak detected from the reference chromatogram data and at least one target peak detected from the target chromatogram data are brought in correspondence with each other;
obtaining a second correspondence in which a reference data set included in the reference chromatogram data and a target data set included in the target chromatogram data are brought in correspondence with each other, by using a first similarity between the second correspondence and the first correspondence; and
correcting the time axis of the target chromatogram data in accordance with the second correspondence.
